(19) United States
(12) Patent Application Publication
(10) Pub. No.: US 2026/0220831 A1
(43) Pub. Date: Jul. 30, 2026

(54) GENERATION OF SYNTHESIZED IMAGES BASED ON INPUT IMAGES

(71) Applicant: Bytedance Technology Ltd., Grand Cayman (KY)

(72) Inventors: Liming Jiang, Los Angeles, CA (US); Qing Yan, Los Angeles, CA (US); Xin Lu, Los Angeles, CA (US); Zichuan Liu, Los Angeles, CA (US); Yumin Jia, Los Angeles, CA (US); Hao Kang, Los Angeles, CA (US)

(21) Appl. No.: 19/190,095

(22) Filed: Apr. 25, 2025

Related U.S. Application Data
(60) Provisional application No. 63/749,352, filed on Jan. 24, 2025.

(51) Int. Cl. G06T 11/00

(52) U.S. Cl. CPC G06T 11/00; G06T 2211/441

(57) ABSTRACT

A computing system receives an input prompt and input images, encodes the input prompt into text embeddings, and extracts facial embeddings representing facial features in the one or more input images. The system further refines the facial embeddings to learn facial similarity features, and inputs a control image and the facial similarity features into a control network to generate features. Then the features, latent noise, and the text embeddings are inputted into a diffusion transformer to generate the synthesized image, and an output is generated based on the synthesized image.

### CROSS REFERENCE TO RELATED APPLICATION

This application claims priority to U.S. Provisional Patent Application Ser. No. 63/749,352, filed Jan. 24, 2025, the entirety of which is hereby incorporated herein by reference for all purposes.

### BACKGROUND

Diffusion models are a class of probabilistic generative models that typically involve two stages: a forward diffusion stage and a reverse denoising stage. In the forward diffusion process, input data is gradually altered and degraded over multiple iterations by adding noise at different scales. In the reverse denoising process, the model learns to reverse the diffusion noising process, iteratively refining an initial image, typically made of random noise, into a fine-grained colorful synthesized image.

Recently, conventional diffusion models have been developed that take as input a text input, image input (e.g., pose image, background image, etc.), or other modes of input, and generate an output image based on the input(s). However, these conventional diffusion models face significant limitations, particularly when tasked with generating images of a known individual. For example, these models often fail to preserve fine-grained facial characteristics of the known individuals in the input images.

### SUMMARY

In view of the above issues, a computing system is provided for generating a synthesized image. The computing system includes a processing circuitry and memory storing instructions that, when executed, cause the processing circuitry to receive an input prompt and one or more input images, encode the input prompt into text embeddings, and extract facial embeddings representing facial features in the one or more input images. The system further refines the facial embeddings to learn facial similarity features, and input a control image and the facial similarity features into a control network to generate features at each of a plurality of control network transformer blocks of the control network. Then the features are inputted at corresponding diffusion network transformer blocks of a diffusion transformer. Latent noise, and the text embeddings are inputted into the diffusion transformer to generate the synthesized image, and an output is generated based on the synthesized image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIG. 2 illustrates a schematic view of the operations of the trained machine learning diffusion model of the computing system of FIG. 1.

FIG. 3 illustrates a detailed schematic of the architectures of the diffusion transformer and the control network of FIGS. 1 and 2.

FIG. 4 illustrates an example implementation of the trained machine learning diffusion model of FIGS. 1 and 2.

FIG. 5 is a flow chart of a method for generating a synthesized image according to an example embodiment of the present disclosure.

FIG. 6 shows an example computing environment of the present disclosure in which the computing system of FIG. 1 may be enacted.

### DETAILED DESCRIPTION

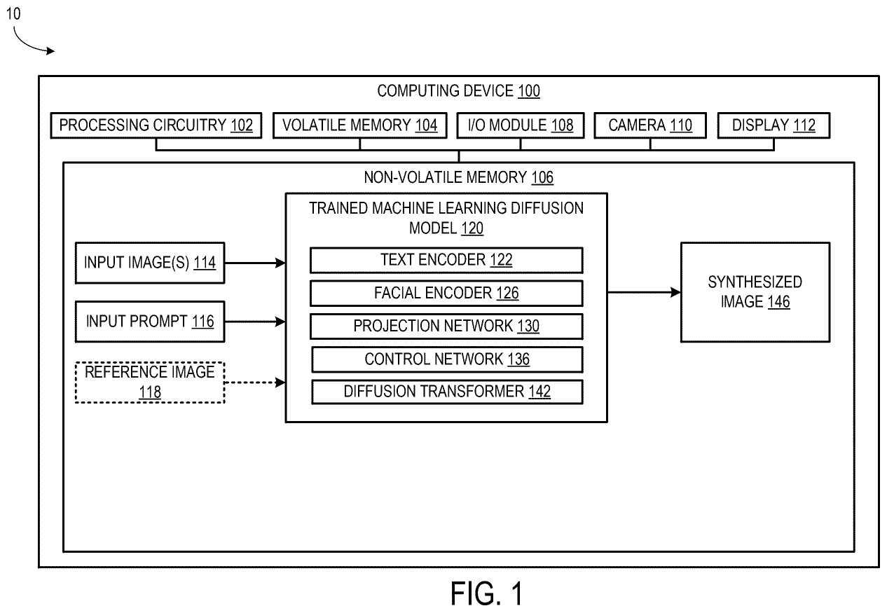

FIG. 1 shows a schematic view of a first example computing system 10 including a computing device 100 for generation of a synthesized image 146 using a trained machine learning diffusion model 120. The computing device 100 includes processing circuitry 102 (e.g., central processing units, or “CPUs”), volatile memory 104, non-volatile memory 106, an input/output (I/O) module 108, a camera 110, and a display 112. The different components are operatively coupled to one another. The non-volatile memory 106 stores instructions to execute the trained machine learning diffusion model 120 which is configured to receive one or more input images 114 and an input prompt 116 and generate the synthesized image 146 based at least on the one or more input images 114 and the input prompt 116.

The trained machine learning diffusion model 120 includes a text encoder 122, a facial encoder 126, a projection network 130, a control network 136, and a diffusion transformer 142. The text encoder 122 is configured to transform the input prompt 116 into text embeddings. The facial encoder 126 is configured to extract facial embeddings representing facial features in the one or more input images 114. The projection network 130 is configured to refine the facial embeddings to learn facial similarity features. The control network 136 is configured to receive input of the facial similarity features and a control image to output features. Text embeddings extracted by the text encoder 122 and features outputted from the control network 136 are inputted into the diffusion transformer 142 to guide the denoising process to generate the synthesized image 146 from latent noise, and an output is generated based on the synthesized image 146. For example, the synthesized image 146 may be outputted for rendering on the display 112 and/or encoded by a video encoder to generate and output a video stream incorporating the synthesized image 146. The synthesized image 146 may be published or shared on a social network platform for viewing by other users of the social network platform.

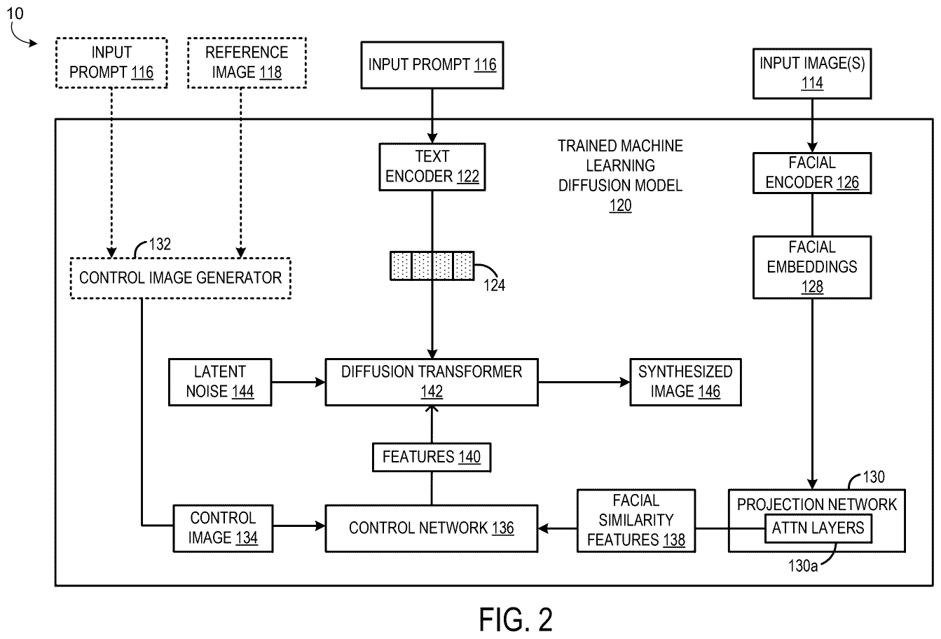

FIG. 2 shows a detailed schematic view of the processes of the trained machine learning diffusion model 120 of FIG. 1 which is configured to receive input of one or more input images 114 and an input prompt 116, and generate and output a synthesized image 146 based on the one or more input images 114 and the input prompt 116.

The trained machine learning diffusion model 120 includes a diffusion transformer 142 and a control network 136. The diffusion transformer 142 may be implemented as a FLUX model that remains frozen during the training phase. The diffusion transformer 142 may accept a latent noise map 144 sampled from a standard Gaussian distribution, and iteratively refine the noise map 144 to generate the synthesized image 146. The control network 136 may be structurally configured similarly to the diffusion transformer 142 but featuring a reduced number of transformer blocks. The control network 136 outputs features 140 that modify the internal feature representations of the diffusion transformer 142 via residual connections.

The trained machine learning diffusion model 120 further includes a facial encoder 126 which is configured to receive one or more input images 114 and extract facial embeddings 128 representing facial features in the one or more input images 114. The projection network 130 further refines these facial embeddings 128 to learn facial similarity features 138. The refined facial similarity features 138 are fed into the control network 136 through the attention layers 130a of the projection network 130, thereby ensuring the alignment of the synthesized image 146 with the facial features in the one or more input images 114.

The input prompt 116 is encoded using the text encoder 122, which transforms the input prompt 116 into text embeddings 124. The text encoder 122 may be configured as a CLIP (Contrastive Language-Image Pre-Training) text encoder, for example. These text embeddings 124 are integrated into the diffusion transformer 142 through its attention layers, thereby ensuring the semantic alignment of the synthesized image 146 with the input prompt 116.

The control network 136 further accepts a control image 134 as input. The control signals represented by the control image 134 are not particularly limited, and may represent information including keypoints, edge maps, and/or depth information. For example, the control image 134 may be a five-facial-keypoint image. Alternatively, the control image 134 may be a pure black image. The control image 134 may be generated by a control image generator 132 using the input prompt 116 and/or a reference image 118, for example. Alternatively, the control image 134 may be manually inputted by a user through manual annotation of the one or more input images 114 or another image, or inputted by motion capture systems which tracks facial features in the one or more input images 114.

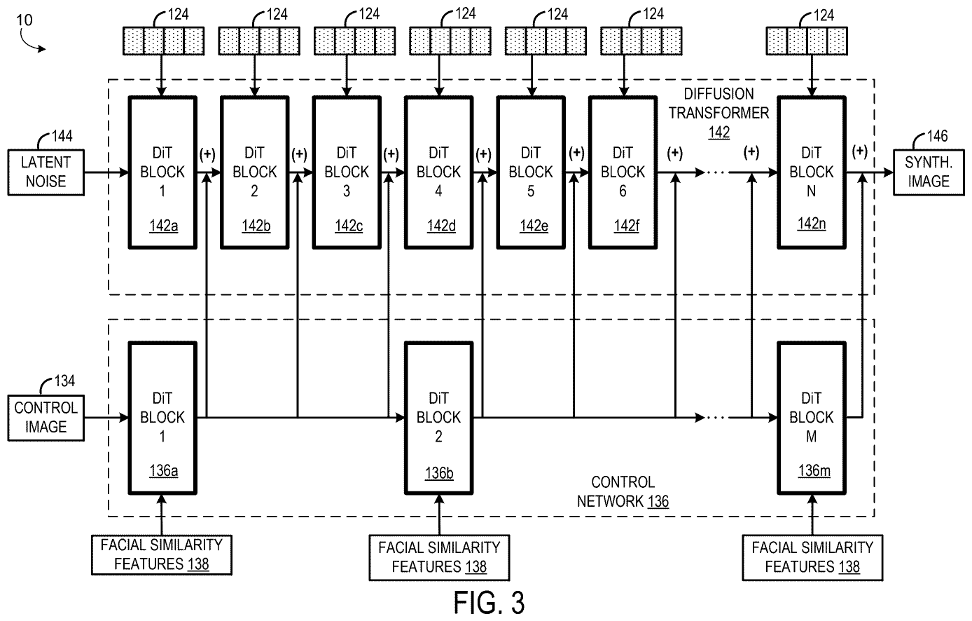

Turning to FIG. 3, the architectures of the control network 136 and the diffusion transformer model 142 are schematically depicted in detail. In this example, the diffusion transformer 142 comprises N number of diffusion network transformer blocks 142a-n, while the control network 136 comprises M number of control network transformer blocks 136a-m. A number of control network transformer blocks 136a-m is less than a number of diffusion network transformer blocks 142a-n. The number of control network transformer blocks 136a-m may be one-half, one-third, or one-fourth the number of diffusion network transformer blocks 142a-n in the diffusion transformer 142, for example. Both the diffusion transformer 142 and the control network 136 produce outputs with the same feature dimensionality. The feature dimensionality may be represented by a 3D tensor. The three dimensions may correspond to batch size, token number, and token length.

Text embeddings 124 are inputted into the transformer blocks 142a-n of the diffusion transformer 142 as the latent noise map 144 is inputted into the diffusion transformer 142 and iteratively refined into the synthesized image 146. Facial similarity features 138 are injected into the transformer blocks 136a-m of the control network 136 as the control image 134 is iteratively refined, as described further with respect to FIG. 3.

In FIG. 3, each transformer block of both the diffusion transformer 142 and the control network 136 is depicted as a rectangular block. Horizontal arrowed lines connect the transformer blocks in the diffusion transformer 142 and the control network 136, illustrating the flow of features. A control image 134 and facial similarity features 138 are inputted into the control network 136 to generate features at each of a plurality of control network transformer blocks 136a-m of the control network 136. Vertical arrowed lines extend from the horizontal connections in the control network 136 to the corresponding horizontal connections in the diffusion transformer 142, so that the features from the control network 136 are inputted at corresponding diffusion network transformer blocks 142a-n of the diffusion transformer 142. These vertical arrows represent the integration of residual features from the control network 136 into the diffusion transformer 142 as the control network 136 predicts the residuals of the diffusion transformer 142. The integration may be performed through an additive operation, in which the residuals predicted by the control network 136 are added to intermediate feature maps of the diffusion transformer 142.

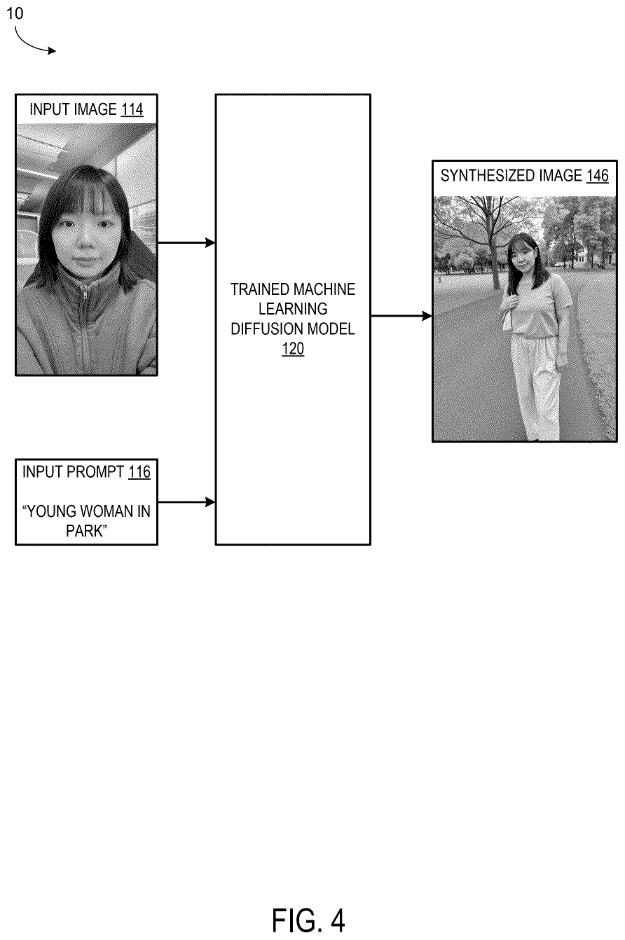

Referring to FIG. 4, an example implementation of the trained machine learning diffusion model 120 of FIGS. 1 and 2 is illustrated. In this example, the input image 114 is a facial portrait of a woman, and the input prompt 116 instructs a “young woman in park”. Responsive to receiving input of the input image 114 and the input prompt 116, the trained machine learning diffusion model 120 generates a synthesized image 146 of a young woman in a park that is in alignment with the input prompt 116 and the facial features identified in the input image 114.

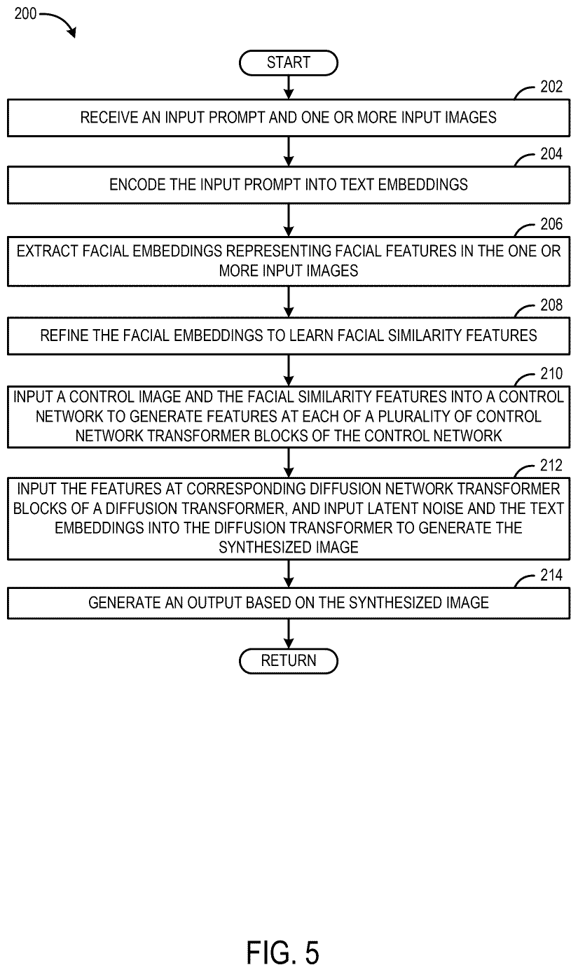

FIG. 5 shows a process flow diagram of an exemplary method 200 for generating a synthesized image. The method 200 may be executed by the processing circuitry 102 and memory 104 of the computing system 10 of FIG. 1. The method 300 includes, at step 202, receiving an input prompt and one or more input images. The method 200 includes, at step 204, encoding the input prompt into text embeddings.

At step 206, the method 200 includes extracting facial embeddings representing facial features in the one or more input images. At step 208, the method 200 includes refining the facial embeddings to learn facial similarity features. At step 210, the method 200 includes inputting a control image and the facial similarity features into a control network to generate features at each of a plurality of control network transformer blocks of the control network. At step 212, the method 200 includes inputting the features at corresponding diffusion network transformer blocks of a diffusion transformer, and input latent noise and the text embeddings into the diffusion transformer to generate the synthesized image. At step 214, the method 200 includes generating an output based on the synthesized image.

As described throughout herein, by leveraging a control network in combination with a diffusion transformer to guide the generation of a synthesized image by injecting residual features, image quality can be enhanced, greater alignment of facial feature with input images can be ensured, and greater semantic alignment with the input prompt can be achieved in generating synthesized images which accurately and effectively represent the facial features of individuals depicted in the input images.

In some embodiments, the methods and processes described herein may be tied to a computing system of one or more computing devices. In particular, such methods and processes may be implemented as a computer-application program or service, an Application Program Interface (API), a library, and/or other computer-program product. In some embodiments, the methods and processes described herein may be tied to a computing system of one or more computing devices. In particular, such methods and processes may be implemented as a computer-application program or service, an API, a library, and/or other computer-program product.

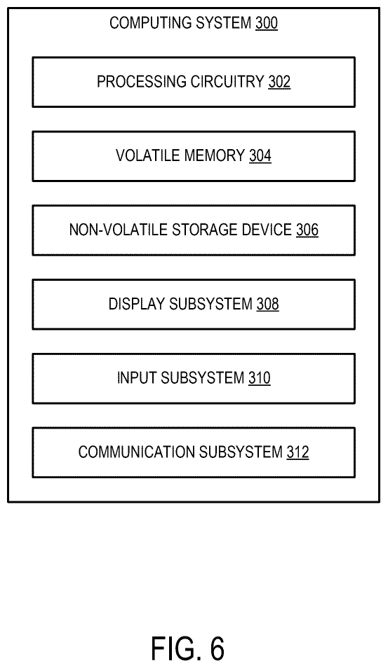

FIG. 6 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 6.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/A SSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional description of the subject matter of the present disclosure. One aspect provides computing system for generating a synthesized image, the computing system comprising processing circuitry and memory storing instructions that, when executed, cause the processing circuitry to receive an input prompt and one or more input images, encode the input prompt into text embeddings, extract facial embeddings representing facial features in the one or more input images, refine the facial embeddings to learn facial similarity features, input a control image and the facial similarity features into a control network to generate features at each of a plurality of control network transformer blocks of the control network, input the features at corresponding diffusion network transformer blocks of a diffusion transformer, and input latent noise and the text embeddings into the diffusion transformer to generate the synthesized image, and generate an output based on the synthesized image. In this aspect, additionally or alternatively, the facial embeddings may be refined using a projection network. In this aspect, additionally or alternatively, the facial similarity features may be fed into the control network through attention layers of the projection network. In this aspect, additionally or alternatively, the text embeddings may be integrated into the diffusion transformer through attention layers of the diffusion transformer. In this aspect, additionally or alternatively, the control network may accept a five-facial-keypoint image as the control image. In this aspect, additionally or alternatively, the latent noise may be sampled from a standard Gaussian distribution. In this aspect, additionally or alternatively, a number of control network transformer blocks may be less than a number of diffusion network transformer blocks. In this aspect, additionally or alternatively, the control network my produce outputs of a same feature dimensionality. In this aspect, additionally or alternatively, the features may be residual features from the control network which are added to intermediate feature maps of the diffusion transformer. In this aspect, additionally or alternatively, the input prompt may be encoded into text embeddings using a CLIP (Contrastive Language-Image Pre-Training) text encoder.

Another aspect provides a computing method for generating a synthesized image, the computing method comprising receiving an input prompt and one or more input images, encoding the input prompt into text embeddings, extracting facial embeddings representing facial features in the one or more input images, refining the facial embeddings to learn facial similarity features, inputting a control image and the facial similarity features into a control network to generate features at each of a plurality of control network transformer blocks of the control network, inputting the features at corresponding diffusion network transformer blocks of a diffusion transformer, and input latent noise, and the text embeddings into the diffusion transformer to generate the synthesized image, and generating an output based on the synthesized image. In this aspect, additionally or alternatively, the facial embeddings may be refined using a projection network. In this aspect, additionally or alternatively, the facial similarity features may be fed into the control network through attention layers of the projection network. In this aspect, additionally or alternatively, the text embeddings may be integrated into the diffusion transformer through attention layers of the diffusion transformer. In this aspect, additionally or alternatively, the control network may accept a five-facial-keypoint image as the control image. In this aspect, additionally or alternatively, the latent noise may be sampled from a standard Gaussian distribution. In this aspect, additionally or alternatively, a number of control network transformer blocks may be less than a number of diffusion network transformer blocks. In this aspect, additionally or alternatively, the control network my produce outputs of a same feature dimensionality. In this aspect, additionally or alternatively, the features may be residual features from the control network which are added to intermediate feature maps of the diffusion transformer. In this aspect, additionally or alternatively, the input prompt may be encoded into text embeddings using a CLIP (Contrastive Language-Image Pre-Training) text encoder.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating a synthesized image, the computing system comprising:
processing circuitry and memory storing instructions that, when executed, cause the processing circuitry to:
receive an input prompt and one or more input images;
encode the input prompt into text embeddings;
extract facial embeddings representing facial features in the one or more input images;
refine the facial embeddings to learn facial similarity features;
input a control image and the facial similarity features into a control network to generate features at each of a plurality of control network transformer blocks of the control network;
input the features at corresponding diffusion network transformer blocks of a diffusion transformer, and input latent noise and the text embeddings into the diffusion transformer to generate the synthesized image; and
generate an output based on the synthesized image.

2. The computing system of claim 1, wherein the facial embeddings are refined using a projection network.

3. The computing system of claim 2, wherein the facial similarity features are fed into the control network through attention layers of the projection network.

4. The computing system of claim 1, wherein the text embeddings are integrated into the diffusion transformer through attention layers of the diffusion transformer.

5. The computing system of claim 1, wherein the control network accepts a five-facial-keypoint image as the control image.

6. The computing system of claim 1, wherein the latent noise is sampled from a standard Gaussian distribution.

7. The computing system of claim 1, wherein a number of control network transformer blocks is less than a number of diffusion network transformer blocks.

8. The computing system of claim 1, wherein the control network produce outputs of a same feature dimensionality.

9. The computing system of claim 1, wherein the features are residual features from the control network which are added to intermediate feature maps of the diffusion transformer.

10. The computing system of claim 7, wherein the input prompt is encoded into text embeddings using a CLIP (Contrastive Language-Image Pre-Training) text encoder.

11. A computing method for generating a synthesized image, the computing method comprising:
receiving an input prompt and one or more input images;
encoding the input prompt into text embeddings;
extracting facial embeddings representing facial features in the one or more input images;
refining the facial embeddings to learn facial similarity features;
inputting a control image and the facial similarity features into a control network to generate features at each of a plurality of control network transformer blocks of the control network;
inputting the features at corresponding diffusion network transformer blocks of a diffusion transformer, and input latent noise, and the text embeddings into the diffusion transformer to generate the synthesized image; and
generating an output based on the synthesized image.

12. The computing method of claim 11, wherein the facial embeddings are refined using a projection network.

13. The computing method of claim 12, wherein the facial similarity features are fed into the control network through attention layers of the projection network.

14. The computing method of claim 11, wherein the text embeddings are integrated into the diffusion transformer through attention layers of the diffusion transformer.

15. The computing method of claim 11, wherein the control network accepts a five-facial-keypoint image as the control image.

16. The computing method of claim 11, wherein the latent noise is sampled from a standard Gaussian distribution.

17. The computing method of claim 11, wherein a number of control network transformer blocks is less than a number of diffusion network transformer blocks.

18. The computing method of claim 11, wherein the control network produce outputs of a same feature dimensionality.

19. The computing method of claim 11, wherein the features are residual features from the control network which are added to intermediate feature maps of the diffusion transformer.

20. The computing method of claim 17, wherein the input prompt is encoded into text embeddings using a CLIP (Contrastive Language-Image Pre-Training) text encoder.
